(19) United States
(12) Patent Application Publication
(10) Pub. No.: US 2016/0371374 A1
(43) Pub. Date: Dec. 22, 2016

(54) Method and Procedure in Displaying Multi-factor Sentiment in Web-pages

(71) Applicant: Connie Chun, Cupertino, CA (US)

(72) Inventor: Connie Chun, Cupertino, CA (US)

(21) Appl. No.: 14/185,675

(22) Filed: Feb. 20, 2014

(51) Int. Cl. G06F 17/30

(52) U.S. Cl. CPC G06F 17/30864; G06F 17/30554; G06F 17/3056; G06F 17/30598

(57) ABSTRACT

Expression of sentiment on critiques and recommendations found in web-pages is an effective tool in helping readers to quickly assess the quality of a product or a service. The concept of incorporating user feedback in web-pages is generally used. Many e-commerce web-sites provide star rating for critiques of products and services. However, it falls short in providing a true picture of the sentiment assessment when a text paragraph may contain context that depicts both good and bad sentiment of varying degree. The current invention is a method and procedure that enables one to depict multi-factor sentiment of products and services in web-pages.

### BACKGROUND OF THE INVENTION

Sentiment is a view or attitude towards an event or subject. It is not an absolute value of how good or how bad, rather, it is a mixture of good and bad of varying degree. While there is no formal measurement of sentiment, it is generally acceptable to use a gradient scale to measure the nature of sentiment from poor to good. As imprecise and subjective as sentiment, sentiment is a mix bag of feelings from positive to negative. This mix bag of feeling by expressing it as a vector of indexes of varying degree over a range. For example, the reading of a paragraph may give the impression to its readers that besides the overall positive sentiment, the reader may acknowledge that there are other elements of negative sentiment. Creative works such as consumer review on products and services come with rating. It describes how one is pleased or displeased with the product or service. Aside from the reference to facts and instances in consumer reviews, a degree of sentiment has an affect on its readers. For all the major e-commerce web sites such as Amazon, Ebay, Macys, Nordstorm, and Yelp, the common display of reviews is rated by a “STAR” system ranging from one to five stars. A consumer writes a review and ranks it with a rating of 1 to 5 stars. A rating of 1 means bad while a rating of 5 means good. This rating system is deficient as an indicator to represent sentiment since it does not express the various degree of gradient over the sentiment spectrum. If the sentiment is not expressed correctly, it can lead to misperception of the quality assessment of product or services at matter.

In the case of sentiment analysis, a multi-factor gradient scale consisting of sentiment indexes to represent various ranks of sentiment from bad to good. This means that if one reads an article of a critique or a review, it will depict varying degree of good to bad sentiment. It is likely one can find some context that expresses good sentiment and some context expresses bad or not so good sentiment. This is called multi-factor sentiment. It is different from the star rating system where the reviewer uses one rating to rate the entire review or article, even when the context expresses both good and bad sentiment.

### SUMMARY

The current invention introduces a novel method and procedure to express multi-factor sentiment in web-pages. In one of the embodiments of the current invention, a classifier uses Naive Bayes Conditional Probability Algorithm commonly known to data scientists to go through a training phase and a testing phase to create a model for classification of known subjects. A supervised procedure is used to sort the critiques according to some fixed sentiment grades with the highest probability being put into each of the corresponding dataset. Classification algorithm is then applied to train the model. The resulting model is created from large amount of training samples found on the INTERNET. The training samples are comprised of consumer reviews and rating associated with each review given by the consumer based on a single number scheme or star(s). These reviews are made up of feature subjects that cover a wide spectrum of categories of products and services. It represents a diversified category of products and services in hundreds of vertical domains, common traits of sentiment expression are vectorized to form the final model. This process enables the creation of a model that provides a more precise ranking with varying gradients of sentiment in the critique. The resulting model enables us to take new instance of critique from any subject domain represented by the model and derives probabilities for each of the sentiment gradient that is defined.

An interactive sentiment analyzer which incorporates the model features is used to process each critique and to compute varying gradient of sentiment. A typical query is consisted of the creative work in its entirety or in paragraphs where distinct concepts are expressed. The classifier algorithm is executed with this model as its baseline to produce a set of sentiment indexes that reflect the sentiment gradient. The resulting set is displayed as bar-graphs, charts, or heat-maps that depicts the multi-factor sentiment in a web-page about the underlying product or service. This new display conveys the sentiment expression graphically that could otherwise be only visualized by one subjectively in reading the article.

### BRIEF DESCRIPTION OF DRAWINGS

FIG. 1 shows a typical web-page review of product and services using multi-factor sentiment display

FIG. 2 shows a flowchart of a method according to aspects of the invention.

FIG. 3 shows a computer network system according to aspects of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. In other instances, well-known features have not been described in detail to avoid obscuring the invention.

Embodiments of the invention provide a method, system, computer network, web-browser, web-server for automatically analyzing the sentiment gradient of a paragraph of text written as a review regarding a product or service for display in a web-page. It displays such sentiment gradients using graphical widgets such as bar-graphs, charts, or heat-maps. In one or more embodiments, the review text is entered through a web-page form and the multi-factor display of sentiment is returned as a feedback for the user to validate.

In one or more embodiments, critiques from existing database or documents with classified star rating are used as input to a classifier as training process where the words are vectorized to form vectors and conditional probability algorithm is used to produce a “classification model”. The model is then used in the “analyze” phase in determining the sentiment indexes of new instances of text paragraphs.

In one or more embodiments, a server program running in a web server will enable a web-service with an Application Program Interface (API). This web-service will accept queries from other web-service clients that use the API to submit text queries for sentiment grading service and get back the sentiment gradient indexes as a response.

In one or more embodiments, critiques from existing database or documents with classified sentiment gradients are used as input datasets to a classifier as training dataset where signatures and semantic networks are used to produce a “classification model”. The model is then used in the “analyze” phase in determining the sentiment gradient of text paragraphs. Sentiment gradient is converted into normalized numeric value of sentiment index.

In one or more embodiments, posting of comments in INTERNET BLOG is submitted to the sentiment analyzer for an instant readout of the sentiment index in the form of graphical display of the sentiment gradient as a feedback for the author and its readers.

In one or more embodiments, posting of text into social networks is submitted to the sentiment analyzer for an instant readout of the sentiment index in the form of graphical display of the sentiment gradient as a feedback for the author and its readers.

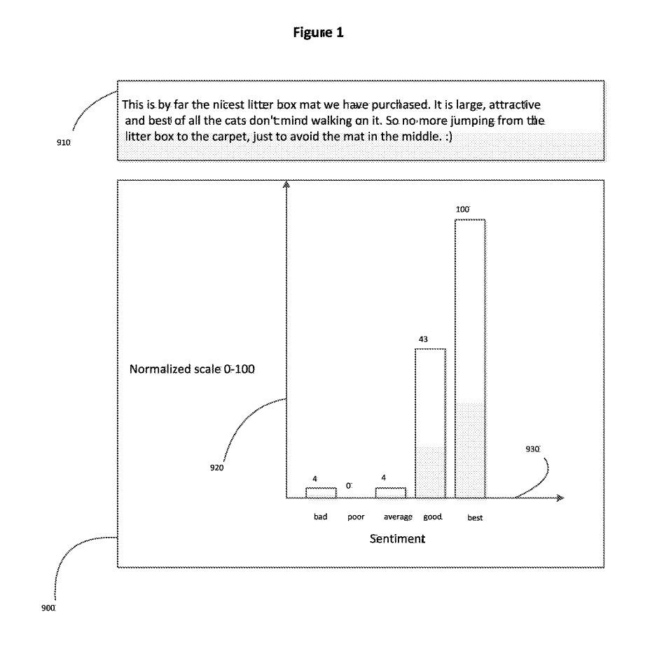

FIG. 1 shows a diagram of a web-page where consumer critique is expressed as review with multi-factor sentiment rating about a product or service. The sample text (910) with sentiment context is displayed on top. The bar-graph depicts the multi-factor display (900). The vertical axis (920) shows the normalized scale. The horizontal axis (930) shows the multi-factor sentiment gradient with index value ranges from 0 to 100 for each of the gradient labeled as bad, poor, average, good, and best.

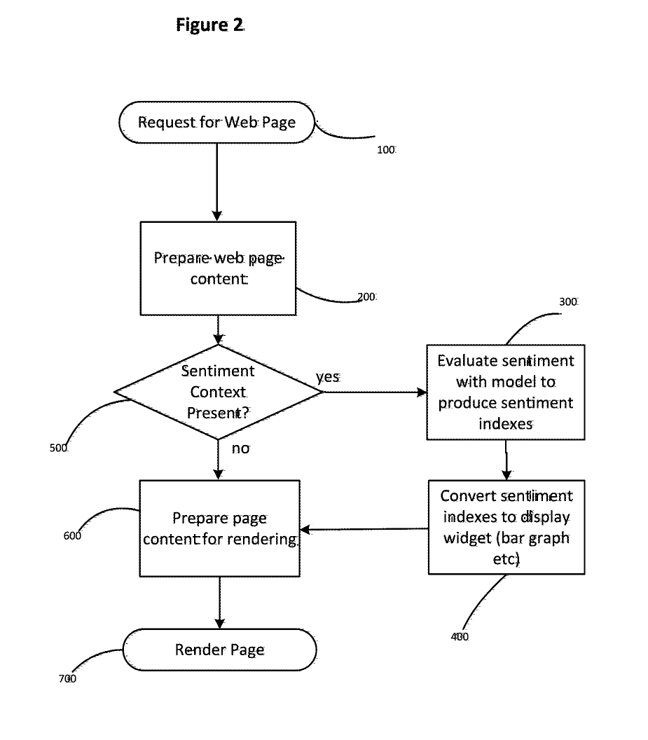

FIG. 2 shows a flowchart of the rendering of a web-page where the content (200) is checked (500) for sentiment context before rendering. If the context contains sentiment context, the sentiment analyzer is called to evaluate the sentiment based on a pre-trained model to produce the sentiment index (300). The output is then converted into a bar-graph (400) to depict the graphical representation of the multi-factor sentiment index. The final web-page is assembled (600) and is then sent to the web-browser for display (700).

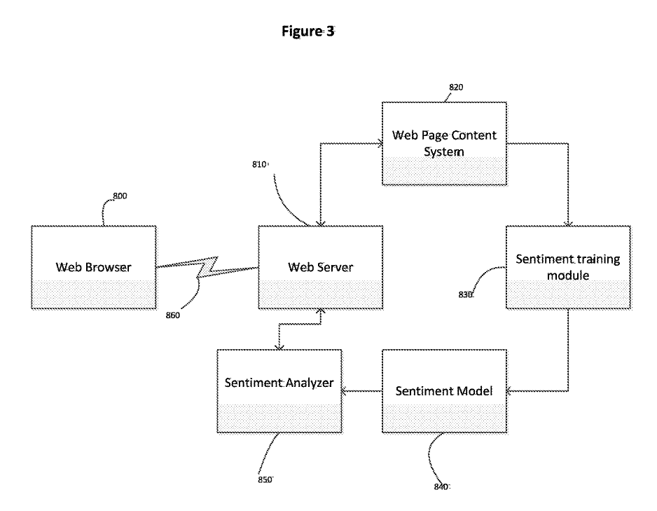

As shown in FIG. 3, the system includes a web-server (810) that answer query from a web-browser (800) over the network (860). The requested content (820) comes from some storage system or sub-system. The content is examined by the web-application running in the web-server for text that would require sentiment analysis. When text for sentiment analysis is required, it calls the sentiment analyzer (850) for sentiment analysis. The sentiment analyzer uses a model which represents some previously trained sentiment model (840) to analyze the text. The result of sentiment analytics is an array of indexes depicting the varying gradient of sentiment. These indexes are translated into display widgets such as a bar-graph depicting the varying degree of sentiment gradient. The content database and the content subsystem (820) provide data for continuous update of the sentiment model (830).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to display multi-factor sentiment on web-pages, comprising:
defining a data source as text with sentiment values,
retrieving, in response to the fetched web-page requests expressed as universal resource locator (URL);
data with sentiment context that enable the classification of the text in sentiment gradient indexes;
converting such gradient indexes into graphical widgets;
inclusion of the widget into the web-page; and
presenting to the web-browser for display.

2. The method of claim 1, further comprising:
obtaining, data source from data submitted through a web-form via a web-browser,
wherein the data is uploaded to the web-server for processing.

3. The method of claim 1, further comprising:
predetermined multi-factor sentiment indexes.

4. The method of claim 1, further comprising:
selecting a sentiment analytics software program that is compatible with the dataset from a catalogue of data analytics software program,
wherein plurality of data analytics software programs to produce results of sentiment indexes.
